(19) United States
(12) Patent Application Publication
(10) Pub. No.: US 2022/0389551 A1
(43) Pub. Date: Dec. 8, 2022

(54) SLOW-TRANSFORMING STEEL ALLOY, METHOD FOR PRODUCING THE SLOW-TRANSFORMING STEEL ALLOY AND HYDROGEN STORE HAVING A COMPONENT MADE FROM SAID SLOW-TRANSFORMING STEEL ALLOY

(71) Applicant: Robert Bosch GmbH, Stuttgart (DE)

(72) Inventors: Matthias Kuntz, Stuttgart (DE); Patrick Fayek, Leonberg (DE); Friedrich Muehleder, Muehlacker (DE)

(21) Appl. No.: 17/776,028

(22) PCT Filed: Oct. 28, 2020
(86) PCT No.: PCT/EP2020/080266

§ 371 Date: May 11, 2022

(30) Foreign Application Priority Data
Nov. 11, 2019 (DE) 10 2019 217 369.1

(51) Int. Cl. C22C 38/44; C22C 38/02; C22C 38/04; C22C 38/00; C22C 38/46; C21D 1/18; C21D 1/26

(52) U.S. Cl. CPC C22C 38/44; C22C 38/02; C22C 38/04; C22C 38/002; C22C 38/46; C21D 1/18; C21D 1/26

(57) ABSTRACT

The invention relates to a slow-transforming steel alloy for a component of a hydrogen store, which component is designed to contain or to be flowed through by hydrogen, wherein the slow-transforming steel alloy has a Vickers hardness of at least 300 HV and the slow-transforming steel alloy contains C, Si, Mn, P, S, Cr, Mo, Ni and/or V as alloy elements, the mass fractions of the alloy elements equaling: —C: at least 0.125% to at most 0.525%, —Si: 0.0% to at most 0.375%, —Mn: 0.0% to at most 0.375%, —P: 0.0% to at most 0.0145%, —S: 0.0% to at most 0.225%, —Cr: 0.0% to at most 0.25%, —Mo: at least 0.81% to at most 4.05%, —Ni: at least 0.50% to at most 3.75% and —V: at least 0.15% to at most 0.45%. The invention furthermore relates to a method for producing the slow-transforming steel alloy and to a hydrogen store having the component consisting of the slow-transforming steel alloy.

### BACKGROUND

EP 1375681 B1 discloses a high-strength steel which is said to have excellent cold toughness and toughness of the heat-affected zone. The high-strength steel, based on mass, contains the alloy elements C: 0.02% to 0.10%, Si: at most 0.8%, Mn: 1.5% to 2.5%, P: at most 0.015%, S: at most 0.003%, Ni: 0.01% to 2.0%, Mo: 0.2% to 0.8%, Nb: at most 0.009%, Ti: at most 0.030%, Al: at most 0.1%, N: at most 0.008%, and optionally V: 0.001% to 0.3%, Cu: 0.01% to 1.0%, Cr: 0.01% to 1.0%, Ca: 0.0001% to 0.01%, REM: 0.0001% to 0.02% and/or Mg: 0.0001% to 0.006%, where the balance consists of Fe and unavoidable impurities; the P value of the steel in the determination by the expression that follows is in the range from 1.9 to 3.5; and the microstructure of the steel is composed mainly of martensite and bainite: P=2.7 C+0.4 Si+Mn+0.8 Cr+0.45 Ni+Cu+2 V+Mo−0.5.

DE 69834932 T2 discloses a sheet metal having a tensile strength of at least 930 MPa. The sheet metal is produced from a reheated steel comprising the following alloy elements in the percentages by weight stated: 0.05% to 0.10% C, 1.7% to 2.1% Mn, less than 0.015% P, less than 0.003% S, 0.001% to 0.006% N, 0.2% to 1.0% Ni, 0.01% to 0.10% Nb, 0.005% to 0.03% Ti, and 0.25% to 0.6% Mo; 0.01% to 0.1% V, less than 1% Cr, less than 1% Cu, less than 0.6% Si, less than 0.06% Al, less than 0.002% B, less than 0.006% Ca, less than 0.02% rare earth metals, and less than 0.006% Mg; balance: iron and unavoidable impurities.

### DETAILED DESCRIPTION

In a first aspect, the invention relates to a slow-transforming steel alloy for a component of a hydrogen storage means which is designed to hold hydrogen or for hydrogen to flow through, wherein the slow-transforming steel alloy has a Vickers hardness of at least 300 HV, wherein the slow-transforming steel alloy contains C, Si, Mn, P, S, Cr, Mo, Ni and/or V as alloy elements, and wherein the proportions by mass of the alloy elements are:

C: at least 0.125% to at most 0.525%,

Si: 0.0% to at most 0.375%,

Mn: 0.0% to at most 0.375%,

P: 0.0% to at most 0.0145%,

S: 0.0% to at most 0.0225%,

Cr: 0.0% to at most 0.25%,

Mo: at least 0.81% to at most 4.05%,

Ni: at least 0.50% to at most 3.75% and

V: at least 0.15% to at most 0.45%.

What is particularly advantageous about the slow-transforming steel alloy according to the first aspect of the invention is that it can be cooled or quenched under air and nevertheless attains good strengths and high hardnesses. As a result, the slow-transforming steel alloy according to the first aspect of the invention enables heat treatment without any specific medium, for example oil or water, for quenching.

Quenching under air compared to quenching with other media is particularly advantageous in the case of large components. Accordingly, the slow-transforming steel alloy is of excellent suitability for a component of a hydrogen storage means which is designed to hold hydrogen or for hydrogen to flow through. Such a component may, for example, be a tank for holding or storing hydrogen, i.e. a hydrogen tank. Such a component may also, for example, be a pipe for hydrogen to flow through or for transporting of hydrogen. Correspondingly, such components are usually of relatively large dimensions. If such components are quenched not under air but with other media in order to achieve the desired good strengths and high hardnesses, the manufacture is correspondingly complex and costly.

Of course, the slow-transforming steel alloy according to the first aspect of the invention is not limited to components of a hydrogen storage means which are designed to hold hydrogen or for hydrogen to flow through, but can also be utilized for other purposes and components. However, it has been found that it is of particularly good suitability for use in a hydrogen atmosphere.

Merely for the sake of completeness, the name of the alloy elements is listed hereinafter: C: carbon, Si: silicon, Mn: manganese, P: phosphorus, S: sulfur, Cr: chromium, Mo: molybdenum, Ni: nickel and V: vanadium. By far the predominant proportion by mass in the slow-transforming steel alloy is formed from Fe: iron.

It is preferable that the proportions by mass of the alloy elements are:

C: at least 0.1875% to at most 0.4375%,

Si: at least 0.0075% to at most 0.3125%,

Mn: at least 0.0075% to at most 0.3125%,

P: at least 0.00225% to at most 0.01125%,

S: at least 0.00225% to at most 0.01875%,

Cr: at least 0.075% to at most 0.125%,

Mo: at least 1.5% to at most 3.375%,

Ni: at least 1.125% to at most 3.125% and

V: at least 0.225% to at most 0.375%.

In this way, it is possible to modify the slow-transforming steel alloy in order to achieve even higher Vickers hardnesses by the quenching under air.

It is further preferable that the proportions by mass of the alloy elements are:

C: at least 0.225% to at most 0.385%,

Si: at least 0.009% to at most 0.275%,

Mn: at least 0.009% to at most 0.275%,

P: at least 0.0027% to at most 0.0099%,

S: at least 0.0027% to at most 0.0165%,

Cr: at least 0.09% to at most 0.11%,

Mo: at least 1.8% to at most 2.92%,

Ni: at least 1.35% to at most 2.75% and

V: at least 0.27% to at most 0.33%.

In this way too, it is possible to further modify the slow-transforming steel alloy in order to achieve even higher Vickers hardnesses after the quenching under air.

It is additionally preferable that the proportions by mass of the alloy elements are:

C: at least 0.25% to at most 0.35%,

Si: at least 0.01% to at most 0.25%,

Mn: at least 0.01% to at most 0.25%,

P: at least 0.003% to at most 0.009%,

S: at least 0.003% to at most 0.015%,

Cr: 0.1%,

Mo: at least 2% to at most 2.7%,

Ni: at least 1.5% to at most 2.5% and

V: 0.3%.

In this way too, it is possible to further modify the slow-transforming steel alloy in order to achieve even higher Vickers hardnesses by the quenching under air.

It is further preferable that the proportions by mass of the alloy elements are:

C: 0.25% or 0.35%,

Si: 0.01% or 0.25%,

Mn: 0.01% or 0.25%,

P: 0.003% or 0.009%,

S: 0.003% or 0.015%,

Cr: 0.1%,

Mo: 2% or 2.7%,

Ni: 1.5% or 2.5% and

V: 0.3%.

For example, a slow-transforming steel alloy may contain proportions by mass of the alloy elements of C: 0.25%, Si: 0.25%, Mn: 0.25%, P: 0.009%, S: 0.015%, Cr: 0.1%, Mo: 2.7%, Ni: 2.5% and V: 0.3%. In addition, for example, a slow-transforming steel alloy may contain proportions by mass of the alloy elements of C: 0.35%, Si: 0.25%, Mn: 0.25%, P: 0.009%, S: 0.015%, Cr: 0.1%, Mo: 2%, Ni: 1.5% and V: 0.3%. Moreover, for example, a slow-transforming steel alloy may contain proportions by mass of the alloy elements of C: 0.35%, Si: 0.01%, Mn: 0.01%, P: 0.003%, S: 0.003%, Cr: 0.1%, Mo: 2%, Ni: 1.5% and V: 0.3%.

It is further preferable that the residual proportion by mass of the slow-transforming steel alloy is formed by Fe. In this respect, the slow-transforming steel alloy does not include any other alloy elements. However, it should be noted that the slow-transforming steel alloy may of course include unintended but possibly unavoidable impurities.

It is also preferable that the slow-transforming steel alloy includes secondary carbides. These may be precipitated in the course of hardening of the slow-transforming steel alloy. More particularly, the alloy elements Mo and V, in the course of annealing treatment of the slow-transforming steel alloy, enable the formation of these secondary carbides. This can achieve an increase in Vickers hardness of 40 HV or more.

It is further preferable that the slow-transforming steel alloy has a tensile strength in the range from 700 MPa to 1500 MPa, especially in the range from 800 MPa to 1200 MPa. Within this tensile strength range, the slow-transforming steel alloy possesses particularly excellent suitability for production of the component of the hydrogen storage means.

In a second aspect, the invention relates to a hydrogen storage means having at least one component designed to hold hydrogen or for hydrogen to flow through, wherein the at least one component consists of a slow-transforming steel alloy of the invention. The at least one component may, for example, be a tank for holding or storing hydrogen, i.e. a hydrogen tank. Alternatively or additionally, the at least one component may, for example, be a pipe for hydrogen to flow through or for transporting of hydrogen. The hydrogen storage means may especially be a mobile hydrogen storage means. Such a mobile hydrogen storage means may be used, for example, in a fuel cell-driven motor vehicle.

In a third aspect, the invention relates to a method of producing a slow-transforming steel alloy of the invention, wherein the slow-transforming steel alloy is quenched under air and/or the slow-transforming steel alloy is annealed. In a first step, the slow-transforming steel alloy may be austenitized. In a second step, the slow-transforming steel alloy may be quenched under air. In a third step, the slow-transforming steel alloy may be annealed. An annealing temperature in the annealing may, for example, be in the range of 200° C. to 800° C., especially 300° C. to 700° C., more particularly 400° C. to 650° C. For example, the annealing temperature may be about 600° C.

1. A slow-transforming steel alloy for a component of a hydrogen storage device which is designed to hold hydrogen or for hydrogen to flow through, wherein the slow-transforming steel alloy has a Vickers hardness of at least 300 HV and the slow-transforming steel alloy contains C, Si, Mn, P, S, Cr, Mo, Ni and/or V as alloy elements, wherein
the proportions by mass of the alloy elements are:
C: at least 0.125% to at most 0.525%,
Si: 0.0% to at most 0.375%,
Mn: 0.0% to at most 0.375%,
P: 0.0% to at most 0.0145%,
S: 0.0% to at most 0.0225%,
Cr: 0.0% to at most 0.25%,
Mo: at least 0.81% to at most 4.05%,
Ni: at least 0.50% to at most 3.75% and
V: at least 0.15% to at most 0.45%.

2. The slow-transforming steel alloy as claimed in claim 1, wherein
the proportions by mass of the alloy elements are:
C: at least 0.1875% to at most 0.4375%,
Si: at least 0.0075% to at most 0.3125%,
Mn: at least 0.0075% to at most 0.3125%,
P: at least 0.00225% to at most 0.01125%,
S: at least 0.00225% to at most 0.01875%,
Cr: at least 0.075% to at most 0.125%,
Mo: at least 1.5% to at most 3.375%,
Ni: at least 1.125% to at most 3.125% and
V: at least 0.225% to at most 0.375%.

3. The slow-transforming steel alloy as claimed in claim 1, wherein
the proportions by mass of the alloy elements are:
C: at least 0.225% to at most 0.385%,
Si: at least 0.009% to at most 0.275%,
Mn: at least 0.009% to at most 0.275%,
P: at least 0.0027% to at most 0.0099%,
S: at least 0.0027% to at most 0.0165%,
Cr: at least 0.09% to at most 0.11%,
Mo: at least 1.8% to at most 2.92%,
Ni: at least 1.35% to at most 2.75% and
V: at least 0.27% to at most 0.33%.

4. The slow-transforming steel alloy as claimed in claim 1, wherein
the proportions by mass of the alloy elements are:
C: at least 0.25% to at most 0.35%,
Si: at least 0.01% to at most 0.25%,
Mn: at least 0.01% to at most 0.25%,
P: at least 0.003% to at most 0.009%,
S: at least 0.003% to at most 0.015%,
Cr: 0.1%,
Mo: at least 2% to at most 2.7%,
Ni: at least 1.5% to at most 2.5% and
V: 0.3%.

5. The slow-transforming steel alloy as claimed in claim 1, wherein
the proportions by mass of the alloy elements are:
C: 0.25% or 0.35%,
Si: 0.01% or 0.25%,
Mn: 0.01% or 0.25%,
P: 0.003% or 0.009%,
S: 0.003% or 0.015%,
Cr: 0.1%,
Mo: 2% or 2.7%,
Ni: 1.5% or 2.5% and
V: 0.3%.

6. The slow-transforming steel alloy as claimed in claim 1, wherein the residual proportion by mass of the slow-transforming steel alloy is formed by Fe.

7. The slow-transforming steel alloy as claimed in claim 1, wherein the slow-transforming steel alloy includes secondary carbides.

8. The slow-transforming steel alloy as claimed in claim 1, wherein the slow-transforming steel alloy has a tensile strength in the range from 700 MPa to 1500 MPa.

9. A method of producing a slow-transforming steel alloy for a component of a hydrogen storage device which is designed to hold hydrogen or for hydrogen to flow through as claimed in claim 1, wherein the slow-transforming steel alloy is quenched under air and/or the slow-transforming steel alloy is annealed.

10. A hydrogen storage device having at least one component which is designed to hold hydrogen or for hydrogen to flow through, wherein the at least one component consists of a slow-transforming steel alloy as claimed in claim 1.
